(19) United States
(12) Patent Application Publication
(10) Pub. No.: US 2008/0112043 A1
(43) Pub. Date: May 15, 2008

(54) Optical system and liquid crystal display apparatus thereof

(75) Inventors: Sean Chang, Taoyuan Hsien (TW); Fang Ho, Taoyuan Hsien (TW); Yang-Lin Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/898,735

(22) Filed: Sep. 14, 2007

(30) Foreign Application Priority Data
Nov. 10, 2006 (TW) 095141670

(51) Int. Cl. G02F 1/355

(52) U.S. Cl. 359/332

(57) ABSTRACT

An optical system includes a light source and a dielectric optical film. The light source generates at least one first light ray having a first spectral distribution, which has a plurality of first peaks with different levels. The dielectric optical film is disposed on an optical path of the first light ray and converts the first light ray into a second light ray, which has a second spectral distribution. The second spectral distribution has a plurality of second peaks with similar levels. In addition, a liquid crystal display apparatus is also disclosed.

### CROSS REFERENCE TO RELATED APPLICATIONS

This Non-provisional application claims priority under 35 U.S.C. §119(a) on Patent Application No(s). 095141670, filed in Taiwan, Republic of China on Nov. 10, 2006, the entire contents of which are hereby incorporated by reference.

### BACKGROUND OF THE INVENTION

1. Field of Invention

The present invention relates to an optical system and a liquid crystal display apparatus thereof. In particular, the present invention relates to an optical system and a liquid crystal display apparatus thereof with the better light uniformity.

2. Related Art

In the modern society, a light source is an indispensable element, and may be applied to the indoor illumination, the vehicle illumination and the display apparatus to provide light rays. The display apparatus, such as a projector or a liquid crystal television, needs the light source for providing uniform light rays so that the apparatus may have the better color representation.

In general, a white light source applied to the display apparatus may include a hot cathode fluorescent lamp (HCFL), a cold cathode fluorescent lamp (CCFL) or a light emitting diode (LED). As for LED, there are various materials correspondingly used to form the LEDs capable of generating white light rays. For example, a LED die for outputting blue light rays is used in conjunction with fluorescent powders for emitting yellow light rays, and the blue light rays excite the fluorescent powders to make them output the yellow light rays, and the blue light rays and the yellow light rays are mixed to form the white light rays. Furthermore, a LED die for outputting purple light rays or ultra-violet rays is used in conjunction with special monochromatic fluorescent powders so that the white light rays may be generated. In addition, an indium gallium nitride (GaInN) die and the fluorescent powders may be disposed in a lens so that the white light rays may be generated.

As shown in FIG. 1, the LED die for outputting the blue light rays is used in conjunction with the fluorescent powders for emitting the yellow light rays, and the analyzed spectral distribution has peak values P₀₁ and P₀₂ at 450 and 585 nm, respectively. The peak values P₀₁ and P₀₂ respectively correspond to a relative intensity. According to the analyzed data, the peak value P₀₁ at 450 nm corresponds to the relative intensity of about 95%, and the peak value P₀₂ corresponds to the relative intensity of about 42%. Consequently, the blue light has the stronger intensity than the yellow light so that the mixed white light is not purer and is biased to the blue. If they are applied to the display apparatus, theirs color representations are influenced and the purity is insufficient.

In addition to the white light source, the same problem may of course rise due to the difference between the relative intensities in the technology of mixing the light rays. In view of this, it is a subject of the present invention to provide an optical system and a liquid crystal display apparatus, in which the highly pure white light composed of the red, green and blue bandwidths may be generated, and the color garishness may thus be enhanced.

### SUMMARY OF THE INVENTION

In view of the foregoing, the present invention is to provide an optical system capable of generating highly pure red, green and blue light rays, and a liquid crystal display apparatus thereof.

To achieve the above, the present invention discloses an optical system including a light source and a dielectric optical film. The light source generates at least one first light ray having a first spectral distribution, which has a plurality of first peaks with different levels. The dielectric optical film is disposed on an optical path of the first light ray for converting the first light ray into a second light ray having a second spectral distribution, which has a plurality of second peaks with similar levels.

To achieve the above, the present invention discloses a liquid crystal display apparatus including a backlight module, a liquid crystal display panel and a dielectric optical film. The backlight module has a housing and at least one light source disposed on the housing. The light source generates at least one first light ray having a first spectral distribution, which has a plurality of first peaks with different levels. The liquid crystal display panel is disposed opposite to the backlight module and has a light outputting surface. The dielectric optical film is disposed between the light source and the light outputting surface for converting the first light ray into a second light ray and emitting the second light ray to the light outputting surface. The second light ray has a second spectral distribution, which has a plurality of second peaks with similar levels.

The above mentioned light source can be a light emitting diode (LED) emitting white lights, a cold cathode fluorescent lamp (CCFL), a hot cathode fluorescent lamp (HCFL) or any other electronic device capable of generating light rays. The dielectric optical film has a plurality of optical layers for converting the first light ray originally having different levels into the second light ray with similar levels.

As mentioned above, the dielectric optical film of the present invention can convert the first light ray originally having different levels into the second light ray having similar levels. Consequently, the second light ray has the highly pure color representation. When the second light ray is white, it can fall on the coordinates of the purer white light in the CIE-1931 model so that the application apparatus thereof has the better color representation.

### BRIEF DESCRIPTION OF THE DRAWINGS

The present invention will become more fully understood from the detailed description given herein below illustration only, and thus is not limitative of the present invention, and wherein:

FIG. 1 is a schematic illustration showing a conventional white light spectral distribution;

FIG. 2 is a schematic illustration showing a light source system according to the preferred embodiment of the present invention;

FIG. 3 is a schematic illustration showing a first spectral distribution of a first light ray generated by the light source in FIG. 2;

FIG. 4 is a schematic illustration showing a second spectral distribution of a second light ray obtained after conversion through the dielectric optical film in FIG. 2;

FIGS. 5A and 5B are schematic illustrations showing emission angles of the first and second light rays in FIG. 2; and

FIG. 6 is a schematic illustration showing a liquid crystal display apparatus according to the preferred embodiment of the present invention.

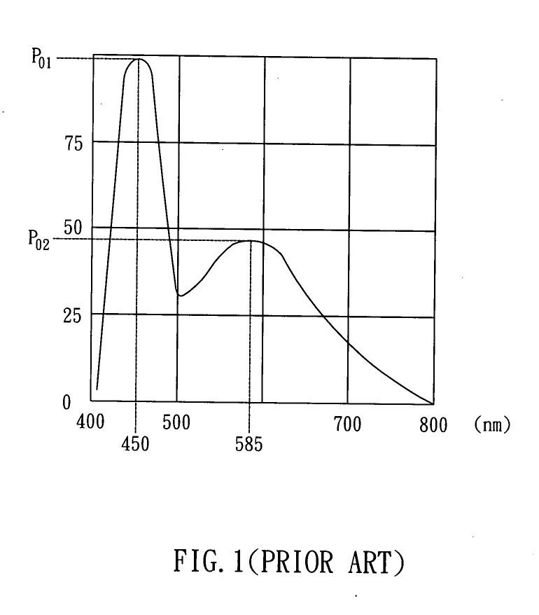

### DETAILED DESCRIPTION OF THE INVENTION

The present invention will be apparent from the following detailed description, which proceeds with reference to the accompanying drawings, wherein the same references relate to the same elements.

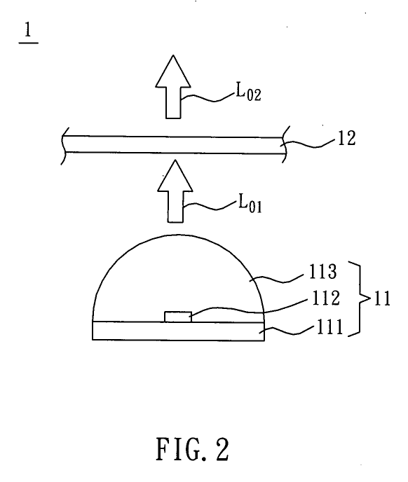

FIG. 2 is a schematic illustration showing an optical system 1 according to the preferred embodiment of the present invention. Referring to FIG. 2, the optical system 1 is applied to a display apparatus, such as, but not limitation to, a liquid crystal display apparatus or a projector. As shown in FIG. 2, the optical system 1 includes a light source 11 and a dielectric optical film 12. The light source 11 may be a light emitting diode (LED), a cold cathode fluorescent lamp (CCFL), a hot cathode fluorescent lamp (HCFL) or any other electronic device capable of generating light rays. In this embodiment, the light source 11 is a LED emitting white lights, and the LED includes a substrate 111, a die 112 and a lens 113. The die 112 is disposed on the substrate 111, and the lens 113 is disposed on the substrate 111 to cover the die 112. The lens 113 may be made of a resin material.

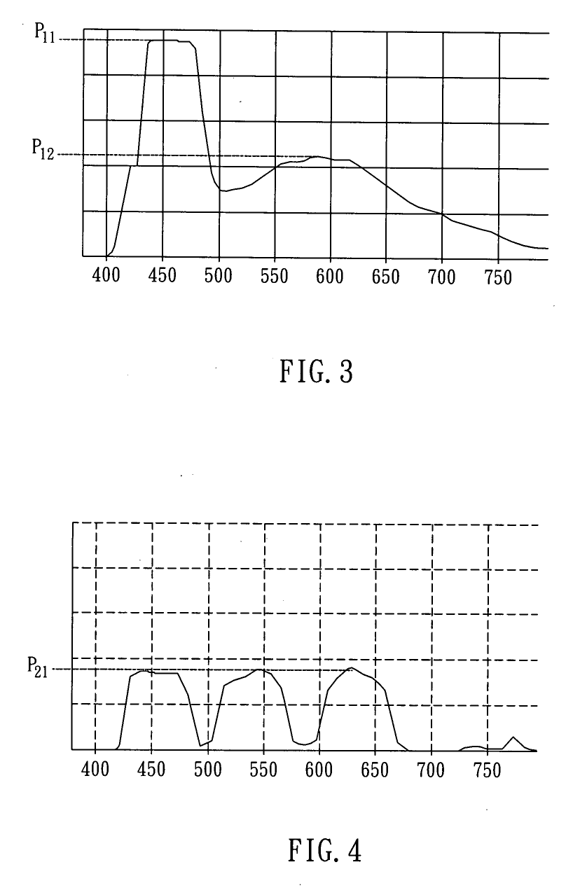

The light source 11 generates at least one first light ray L₀₁ having a first spectral distribution, which has a plurality of first peaks with different levels, wherein the level is a relative intensity of light. In this embodiment, the light source 11 is a white light source. That is, the first light ray L₀₁ is white. Of course, the light source may also output other colors of light and is not particularly restricted. As shown in FIG. 3, the first spectral distribution has two first peaks P₁₁ and P₁₂ respectively ranging from 400 to 500 nm and from 500 to 700 nm. That is, the peaks respectively fall within the ranges of the blue light wavelength and the yellow light wavelength.

As shown in FIG. 2, the dielectric optical film 12 is disposed on an optical path of the first light ray L₀₁, the first light ray L₀₁ is converted into a second light ray L₀₂ after entering the dielectric optical film 12, and the second light ray L₀₂ is outputted from the dielectric optical film 12. The second light ray L₀₂ has a second spectral distribution having a plurality of second peaks P₂₁ with similar levels. Preferably, the levels of the second peaks P₂₁ of the second spectrum distribution are the same. Herein, the level may also be the relative intensity of light.

In this embodiment, the dielectric optical film 12 is composed of a plurality of optical layers, which includes at least one low-refractivity film material and at least one high-refractivity film material. The low-refractivity film material may be silicon dioxide (SiO₂), magnesium fluoride (MgF₂), and so on. Also, the high-refractivity film material may be aluminum nitride (AlN), tantalum oxide (Ta₂O₅), titanium oxide (TiO₂), zirconium oxide (ZrO₂), niobium oxide (Nb₂O₅), and so on. The optical layers may be formed on a transparent substrate, the lens of the LED or a secondary optical device (not shown) of the LED by way of evaporation. As shown in FIG. 4, the second spectral distribution has three second peaks P₁₁, P₁₂ and P₁₃ respectively ranging from 430 to 490 nm, from 490 to 560 nm and from 570 to 650 nm. That is, the second peaks P₁₁, P₁₂ and P₁₃ respectively fall within the ranges of the blue, green and red wavelengths.

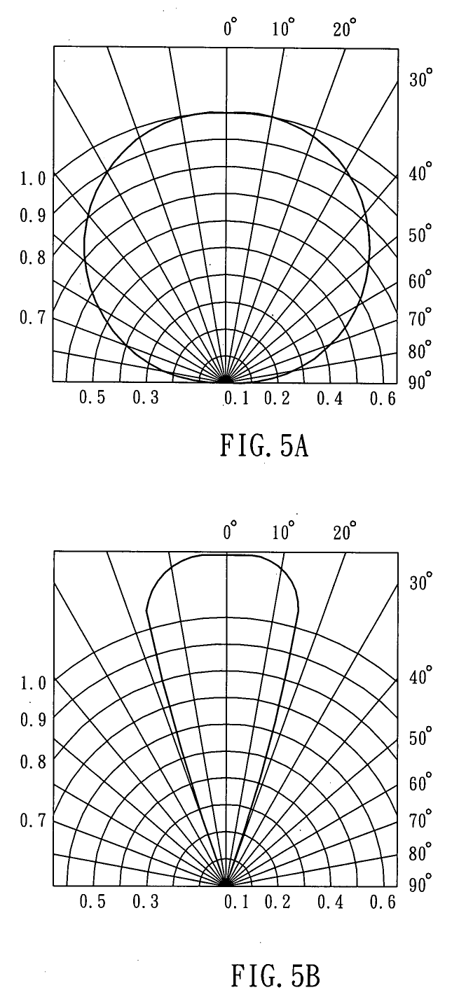

As shown in FIG. 5A, the divergence angle of the first light ray L₀₁ is about 80 degrees in this embodiment. As shown in FIG. 5B, the dielectric optical film 12 is more sensitive to the angle due to the optical property of the dielectric optical film 12, so the optical frequency is shifted too much once the angle is too large, and thus the effect is poor. Consequently, the light ray emitted from the light source may be preferably much more concentrated. That is, the divergence angle of the second light ray is preferably smaller than 15 degrees. Alternatively, the dielectric optical film 12 is placed at a position where the divergence angle is relatively smaller in the system. As mentioned hereinabove, the dielectric optical film 12 can convert the first light ray L₀₁ with the unbalanced bandwidth distributions of the three primary colors into the second light ray L₀₂ with the balanced distributions so that the color representation is enhanced.

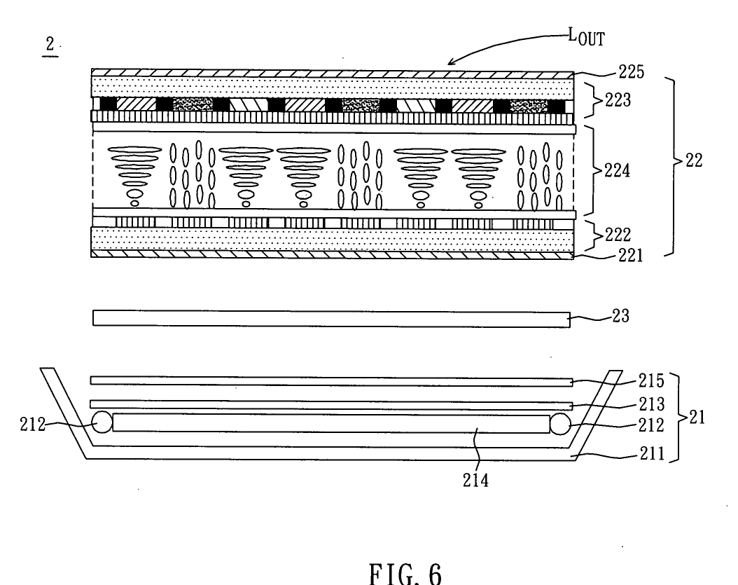

FIG. 6 is a schematic illustration showing a liquid crystal display apparatus 2 according to the preferred embodiment of the present invention. As shown in FIG. 6, the liquid crystal display apparatus 2 according to the preferred embodiment of the present invention includes a backlight module 21, a liquid crystal display panel 22 and a dielectric optical film 23.

The backlight module 21 may be a direct type backlight module or a side-edge type backlight module. Herein, the backlight module 21 is a side-edge type backlight module in this illustrated example. The backlight module 21 has a housing 211 and at least one light source 212. The light source 212 is disposed on the housing 211 and generates at least one first light ray, which has a first spectral distribution. The first spectral distribution has a plurality of first peaks with different levels.

The liquid crystal display panel 22 is disposed opposite to the backlight module 21 and has a light outputting surface LOUT. The dielectric optical film 23 is disposed between the light source 212 of the backlight module 21 and the light outputting surface LOUT of the liquid crystal display panel 22. The dielectric optical film 23 converts the first light ray into a second light ray, which is sequentially transmitted to the light outputting surface LOUT. The second light ray has a second spectral distribution, which has a plurality of second peaks with similar levels.

In this embodiment, the light source 212 of the backlight module 21 and the dielectric optical film 23 have the variations, structures and functions the same as those of the light source 11 and the dielectric optical film 12 of FIG. 2, so detailed descriptions thereof will be omitted.

The components of the liquid crystal display apparatus 2 will be described with reference to FIG. 6. As shown in FIG. 6, a side-edge type backlight module is illustrated in this embodiment. So, the backlight module 21 further includes a diffuser plate 213, a light guide plate 214 and a brightness enhancement film 215. The diffuser plate 213 is disposed between the housing 211 and the liquid crystal display panel 22. The light guide plate 214 is disposed between the housing 211 and the diffuser plate 213. The brightness enhancement film 215 is disposed between the diffuser plate 213 and the liquid crystal display panel 22.

The liquid crystal display panel 22 further has a lower polarizer 221, a pixel array substrate 222, a color filter 223, a liquid crystal layer 224 and an upper polarizer 225. The pixel array substrate 222 is disposed on the lower polarizer 221. The color filter 223 is disposed opposite to the pixel array substrate 222. The liquid crystal layer 224 is disposed between the pixel array substrate 222 and the color filter 223. The upper polarizer 225 is disposed on the color filter. In this embodiment, the light outputting surface LoUT is located on the upper polarizer 225.

As mentioned hereinabove, the dielectric optical film 23 may be disposed or formed at any position on or between the diffuser plate 213, the light guide plate 214, the brightness enhancement film 215, the lower polarizer 221, the pixel array substrate 222, the color filter 223 or the upper polarizer 225. In this embodiment, the dielectric optical film 23 is disposed between the brightness enhancement film 215 and the lower polarizer 221.

In summary, the dielectric optical film of the present invention converts the first light ray with the unbalanced frequency bandwidth distribution into the second light ray with the balanced frequency bandwidth distribution, and the second light ray can be outputted. That is, the first light ray having different relative intensities of light is converted into the second light ray having similar relative intensities of light. As the results, the second light ray has the highly pure color representation. When the second light ray is white, it can fall on the coordinates of the purer white light in the CIE-1931 model so that the application apparatus thereof has the better color representation.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. An optical system, comprising:
a light source for generating at least one first light ray having a first spectral distribution, wherein the first spectral distribution has a plurality of first peaks with different levels; and
a dielectric optical film disposed on an optical path of the first light ray for converting the first light ray into a second light ray having a second spectral distribution, wherein the second spectral distribution has a plurality of second peaks with similar levels.

2. The optical system according to claim 1, wherein the light source is a light emitting diode (LED) emitting white lights, a hot cathode fluorescent lamp (HCFL) or a cold cathode fluorescent lamp (CCFL).

3. The optical system according to claim 2, wherein the level is a relative intensity of light.

4. The optical system according to claim 2, wherein the first spectral distribution has two first peaks, and the first peaks range from 400 to 500 nm or from 500 to 700 nm.

5. The optical system according to claim 2, wherein the second spectral distribution has three second peaks, and the second peaks range from 430 to 490 nm, from 490 to 560 nm or from 570 to 650 nm.

6. The optical system according to claim 2, wherein the dielectric optical film has a plurality of optical layers, and the optical layers comprise at least one low-refractivity film material and at least one high-refractivity film material.

7. The optical system according to claim 6, wherein the low-refractivity film material comprises silicon dioxide (SiO₂) or magnesium fluoride (MgF₂).

8. The optical system according to claim 6, wherein the high-refractivity film material comprises aluminum nitride (AlN), tantalum oxide (Ta₂O₅), titanium oxide (TiO₂), zirconium oxide (ZrO₂) or niobium oxide (Nb₂O₅).

9. The optical system according to claim 2, wherein a divergence angle of the second light ray is determined according to an optical property of the dielectric optical film.

10. The optical system according to claim 9, wherein the divergence angle of the second light ray is smaller than 15 degrees.

11. The optical system according to claim 2, wherein the LED comprises a die and a lens, and the dielectric optical film is formed on the lens.

12. The optical system according to claim 11, wherein the LED further comprises a secondary optical device which covers the lens and the die, and the dielectric optical film is formed on the secondary optical device.

13. A liquid crystal display apparatus, comprising:
a backlight module having a housing and at least one light source disposed on the housing, wherein the light source generates at least one first light ray having a first spectral distribution, and the first spectral distribution has a plurality of first peaks with different levels;
a liquid crystal display panel disposed opposite to the backlight module and having a light outputting surface; and
a dielectric optical film disposed between the light source and the light outputting surface for converting the first light ray into a second light ray and emitting the second light ray to the light outputting surface of the liquid crystal display panel, wherein the second light ray has a second spectral distribution, and the second spectral distribution has a plurality of second peaks with similar levels.

14. The apparatus according to claim 13, wherein the level is a relative intensity of light, and the light source is a white light source.

15. The apparatus according to claim 13, wherein the dielectric optical film has a plurality of optical layers, and the optical layers comprise at least one low-refractivity film material and at least one high-refractivity film material.

16. The apparatus according to claim 13, wherein the backlight module further comprises a diffuser plate disposed between the housing and the liquid crystal display panel, and the dielectric optical film is disposed or formed on the diffuser plate.

17. The apparatus according to claim 16, wherein the backlight module further comprises a light guide plate disposed between the housing and the diffuser plate, and the dielectric optical film is disposed or formed on the light guide plate.

18. The apparatus according to claim 16, wherein the backlight module further comprises a brightness enhancement film disposed between the diffuser plate and the liquid crystal display panel, and the dielectric optical film is disposed or formed on the brightness enhancement film.

19. The apparatus according to claim 13, wherein the liquid crystal display panel further comprises:
a lower polarizer;
a pixel array substrate disposed on the lower polarizer;
a color filter disposed opposite to the pixel array substrate;
a liquid crystal layer disposed between the pixel array substrate and the color filter; and
an upper polarizer disposed on the color filter.

20. The apparatus according to claim 19, wherein the dielectric optical film is disposed or formed on the lower polarizer, the pixel array substrate, the color filter or the upper polarizer or a location between the lower polarizer, the pixel array substrate, the color filter and the upper polarizer.
